(19) United States
(12) Patent Application Publication
(10) Pub. No.: US 2012/0279075 A1
(43) Pub. Date: Nov. 8, 2012

(54) IMPROVED BATTERY HOUSING FOR BATTERY-POWERED DEVICE

(76) Inventor: Klaus Günter Amsel, Schmitten (DE)

(21) Appl. No.: 13/098,511

(22) Filed: May 2, 2011

(51) Int. Cl. B26B 21/00

(52) U.S. Cl. 30/526; 30/32

(57) ABSTRACT

An improved housing for battery-powered devices is provided. The housing is configured to hold at least one battery. A surface within the housing includes a housing wall. A self-adhering insulation sleeve located between the housing wall and the battery. The self-adhering insulation sleeve includes a coated surface and a non-coated surface. A layer of adhesive on the coated surface of the self-adhering insulation sleeve.

### FIELD OF THE INVENTION

This invention relates to battery housings for battery-powered devices. Particularly the invention relates to housings for razors for shaving that include battery-powered functionality.

### BACKGROUND OF THE INVENTION

Battery-powered, portable devices have broad application and examples include razors, mobile devices, children's toys, computers, and the like. These devices may include a battery housing within which a battery, or batteries, may be placed. A user may be able to insert and remove the batteries from the housing through an opening having a cover. Alternatively, the batteries may be permanently affixed within the housing, e.g., the battery may not be inserted and replaced by the user.

The device being portable, however, may experience various degrees of movement during use. It is undesirable that the battery or batteries move or rattle around within the housing, as this may damage the batteries and/or the device. The battery may generally include an insulating sleeve, such as a label, on the external surface of the battery. The label may help prevent battery shorting within the housing. A battery may short if a direct electrical path is made across the anode and cathode, or the poles, of the battery. The label on the battery may be damaged during shipment, insertion within the device, or during device use. There is potential that the battery may experience a short if the label is damaged, and electrical contact is made between the battery and a conductive element within the housing, such as the housing wall, electric circuit components, and the like. A battery that shorts may generate excess internal gas that may lead to electrolyte leakage. Damage to the device or injury to the consumer may result should battery leakage occur.

An additional insulating sleeve may be included within the housing of the device to help reduce the likelihood of shorting. It is generally preferable that the insulating sleeve remain in place after insertion into the housing. This is particularly so for devices that a user may be able to insert and remove batteries from the housing. The insulating sleeve may be affixed to the housing with tape. The use of tape prevents the insulating sleeve from shifting during the insertion or removal of a battery by the user. The application of the tape, however, adds complexity to the device design and the device's manufacture.

### SUMMARY OF THE INVENTION

The present invention provides an improved housing for battery-powered devices. In some implementations, the improved housing pertains to razors for shaving that include battery-powered functionality.

In one aspect the invention features a battery-powered device including: (a) a housing constructed to hold at least one battery; (b) a surface that includes a housing wall; (c) a self-adhering insulation sleeve located between the housing wall and the battery; (d) the self-adhering insulation sleeve includes a coated surface and a non-coated surface; and (e) a layer of adhesive on the coated surface of the self-adhering insulation sleeve.

Some implementations include one or more of the following features. The self-adhering insulation sleeve may be a polymer film. The polymer film may include polyvinyl chloride, polyvinyl fluoride, vinylidine fluoride, polyester, polyolefin, polypropylene, polyethylene, polyethylene terephthalate, polyamide, polystyrene, and mixtures thereof. The polymer film may include an eco-friendly recyclable or biodegradable material. The adhesive may be a pressure-sensitive adhesive. The pressure-sensitive adhesive may be acrylic, butyl rubber, ethylene vinyl acetate, natural rubber, nitrile, silicone rubber, styrene block co-polymer, and mixtures thereof. The pressure-sensitive adhesive may include an eco-friendly recyclable or biodegradable material. The self-adhering insulation sleeve may include at least one indicia on the non-coated surface. The indicia may include branding, battery orientation, battery type, voltage, and combinations thereof. The housing may include electrically-conductive paths disposed between the housing wall and the battery. The battery-powered may be a razor.

In another aspect the invention features a handle for a razor with battery-powered functionality including: (a) a housing constructed to hold at least one battery; (b) a self-adhering insulation sleeve located between the housing wall and the battery; (c) the self-adhering insulation sleeve includes a coated surface and a non-coated surface; and (d) a layer of adhesive on the coated surface of the self-adhering insulation sleeve.

Some implementations include one or more of the following features. The housing may include a carrier fixed within the housing made of metal. The carrier may include a pair of opposing battery clamp fingers configured to exert a clamping force against the battery for restricting the battery from moving out of the chamber through the open end. The fingers may extend longitudinally, parallel to the length of the battery. Electrical contact may be established between a battery shell and the carrier when the battery shell is placed on said open end of said battery chamber. The clamping force may be sufficient to prevent the battery from falling out of the housing when the housing is held with a long axis of the housing oriented vertically. Each finger may exert a spring force of about 0.5 N when a battery having a diameter of 9.5 mm is inserted into the housing, and less than about 2.5 N when a battery having a diameter of 10.5 mm is inserted into the housing.

The self-adhering insulation sleeve may be a polymer film. The polymer film may include polyvinyl chloride, polyvinyl fluoride, vinylidine fluoride, polyester, polyolefin, polypropylene, polyethylene, polyethylene terephthalate, polyamide, polystyrene, and mixtures thereof. The polymer film may include an eco-friendly recyclable or biodegradable material. The adhesive may be a pressure-sensitive adhesive. The pressure-sensitive adhesive may be acrylic, butyl rubber, ethylene vinyl acetate, natural rubber, nitrile, silicone rubber, styrene block co-polymer, and mixtures thereof. The pressure-sensitive adhesive may include an eco-friendly recyclable or biodegradable material. The self-adhering insulation sleeve may include at least one indicia on the non-coated surface. The indicia may include branding, battery orientation, battery type, voltage, and combinations thereof. The housing may include electrically-conductive paths disposed between the housing wall and the battery.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a perspective view of a self-adhering insulation sleeve of the present invention.

FIG. 2 is a side view of the self-adhering insulation sleeve of FIG. 1.

FIG. 3A is an indicia included within a non-coated surface of the self-adhering insulation sleeve.

FIG. 3B is another indicia included within the non-coated surface of the self-adhering insulation sleeve.

FIG. 3C is another indicia included within the non-coated surface of the self-adhering insulation sleeve.

FIG. 3D is another indicia included within the non-coated surface of the self-adhering insulation sleeve.

FIG. 3E is another indicia included within the non-coated surface of the self-adhering insulation sleeve.

FIG. 4 is a top view of a razor handle of the present invention.

FIG. 5 is a partially exploded view of the razor handle of FIG. 4.

FIG. 6 is a perspective view of a head tube exploded from a grip tube of the razor.

FIG. 7 is an exploded view of the grip tube showing a set of components contained therein.

FIG. 8 is an exploded view illustrating an assembly of the components contained in the grip tube.

FIG. 9A is an enlarged detail view of the bayonet assembly used in the razor of FIG. 4.

FIG. 9B is an enlarged detail view of the bayonet assembly with the male and female components engaged and the bayonet and a set of battery springs compressed.

FIG. 10 is a cross-sectional view of the battery shell.

### DETAILED DESCRIPTION OF THE INVENTION

A battery-powered device may include a housing constructed to hold a battery. The battery may have a label on an outer surface. The housing may have a surface that comprises a housing wall. The housing may have a self-adhering insulation sleeve affixed to the housing wall. The self-adhering insulation sleeve may be disposed between the housing wall and the battery. The self-adhering insulation sleeve may cover the surface of the housing wall. The self-adhering insulation sleeve may cover the surface of the housing wall that runs parallel with the external surface of the battery when the battery is within the housing. The housing may include electrically-conductive paths disposed between the housing wall and the battery. The self-adhering insulation sleeve may be affixed over the electrically-conductive paths.

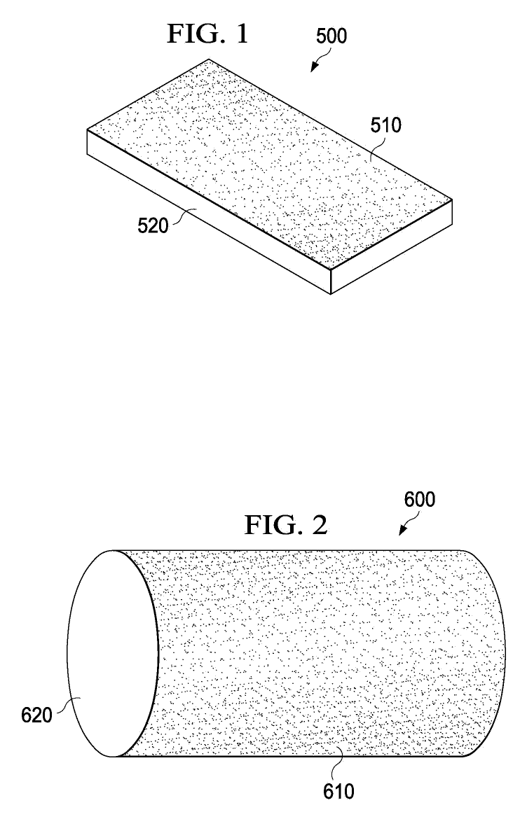

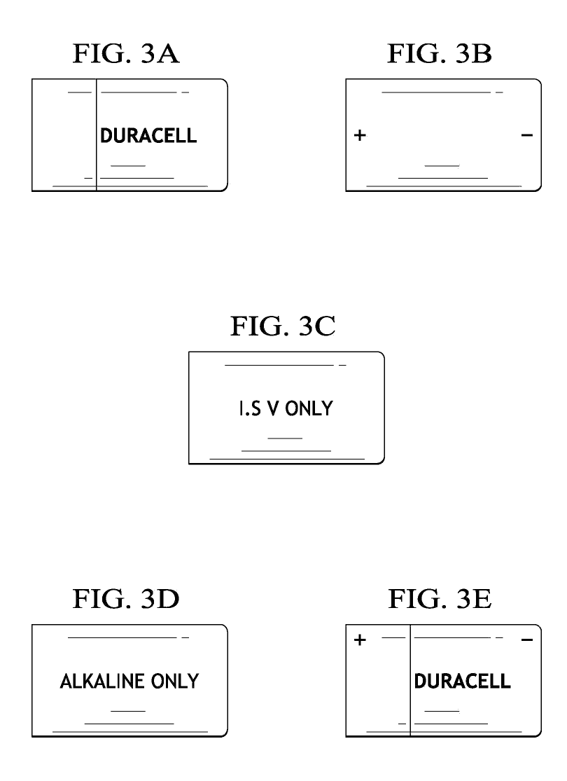

The self-adhering insulation sleeve may be in any shape that conforms to the surface of the housing. Referring to FIGS. 1 and 2, the self-adhering insulation sleeve may be, e.g., rectangular 500 or tubular 600. As shown in FIG. 2, the self-adhering insulation sleeve may be a continuous tube. The self-adhering insulation sleeve may be a tube formed from a sheet of polymer film.

The self-adhering insulation sleeve may comprise a polymer film. Examples of polymer film include polyvinyl chloride, polyvinyl fluoride, vinylidine fluoride, polyester, polyolefin, polypropylene, polyethylene, polyethylene terephtalate, polyamide, polystyrene, and mixtures thereof. The polymer film may be beneficially made of an eco-friendly biodegradable or recyclable material or materials.

Further referring to FIGS. 1 and 2, the self-adhering insulation sleeve may comprise a coated surface 510, 610 and a non-coated surface 520, 620 opposite the coated surface 510, 610. The coated surface 510, 610 may include an adhesive. The adhesive may comprise a pressure-sensitive adhesive. Examples of pressure-sensitive adhesives include acrylic, butyl rubber, ethylene vinyl acetate, natural rubber, nitrile, silicone rubber, styrene block co-polymer, and mixtures thereof. The adhesive may be beneficially made of an eco-friendly biodegradable or recyclable material or materials.

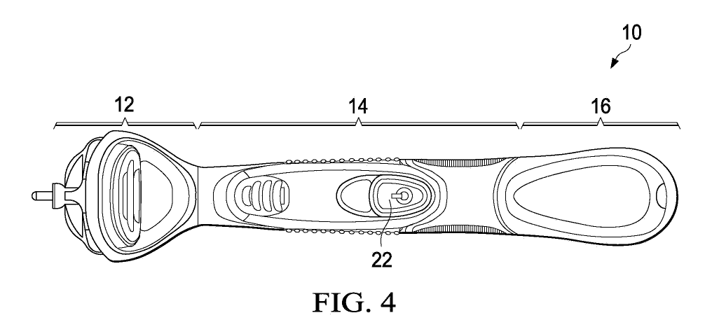

The non-coated surface 520, 620 of the self-adhering insulation sleeve may include at least one indicia. Referring to FIGS. 3A, 3B, 3C, 3D, and 3E, examples of indicia include branding, battery orientation, voltage, battery type, and combinations thereof.

A battery-powered razor is further described below to illustrate a non-limiting embodiment of the invention described herein.

### Overall Razor Structure

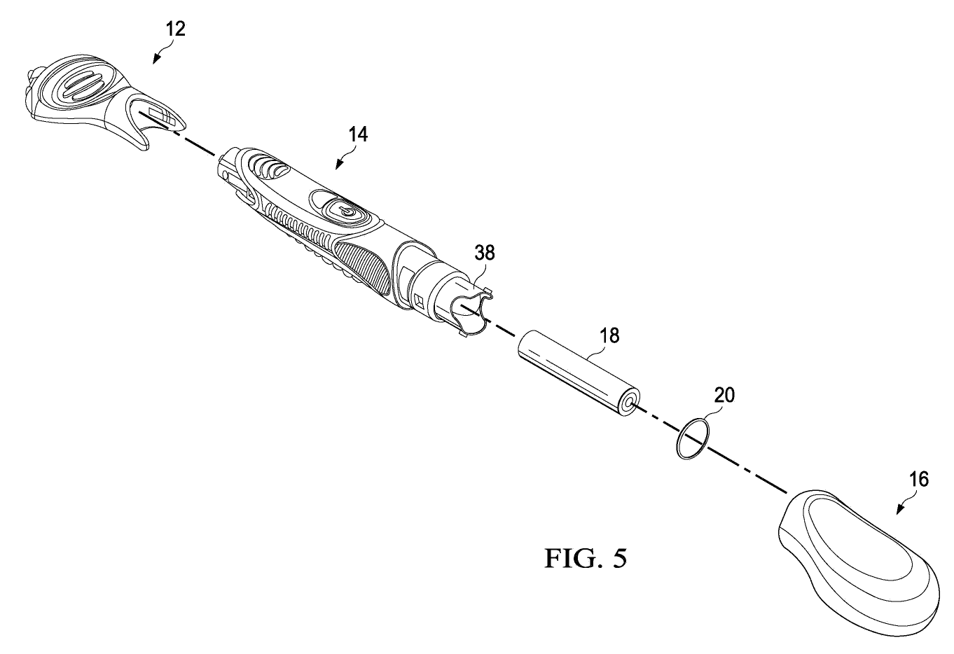

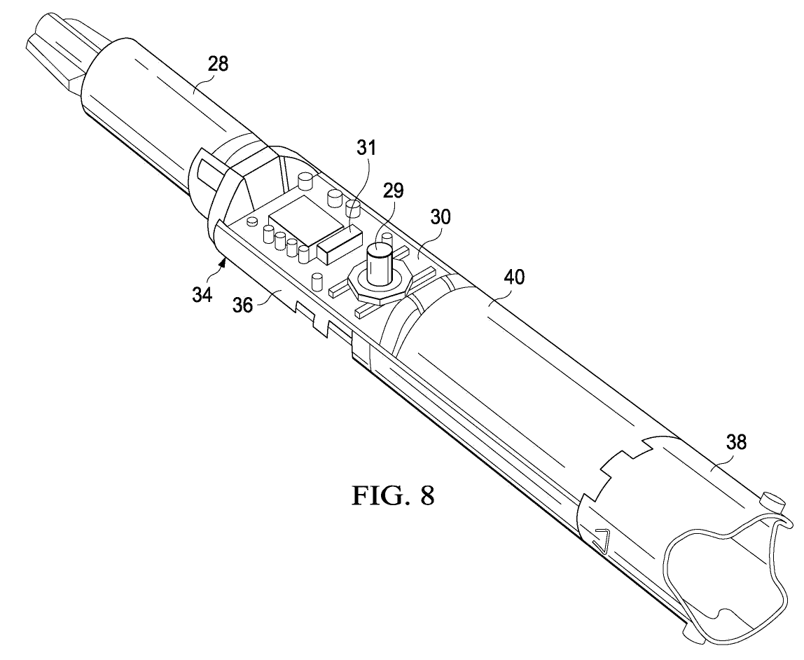

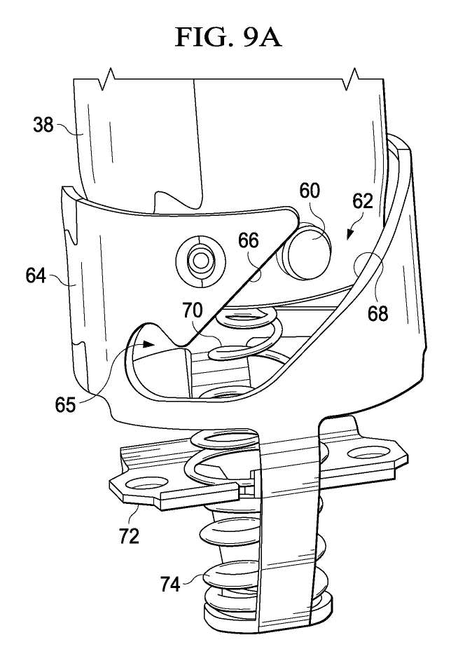

Referring to FIG. 4, a razor handle 10 includes a razor head 12, a grip tube 14, and a battery shell 16. The razor head 12 includes a connecting structure for mounting a replaceable razor cartridge (not shown) on the handle 10, as is well known in the razor art. The grip tube 14 is constructed to be held by a user during shaving, and to contain the components of the razor that provide the battery-powered functionality of the razor, e.g., a printed circuit board and a motor configured to cause vibration. The grip tube is a sealed unit to which the head 12 is fixedly attached, allowing modular manufacturing and providing other advantages which will be discussed below. The grip tube 14 includes an actuator button 22 that may be pressed by the user to actuate the battery-powered functionality of the razor via an electronic switch 29 (FIGS. 7 and 8).

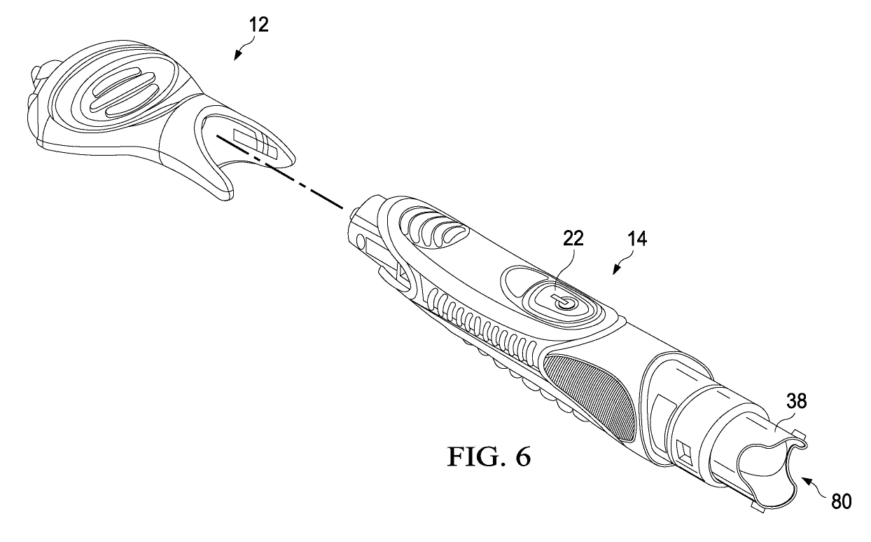

Referring to FIG. 5, the battery shell 16 is removably attached to the grip tube 14, so that the user may remove the battery shell to replace the battery 18. The interface between the battery shell and grip tube is sealed, e.g., by an O-ring 20, providing a water-tight assembly to protect the battery and electronics within the razor. The O-ring 20 is generally mounted in a groove (not shown) on the grip tube, e.g., by an interference fit.

### Modular Grip Tube Structure

As shown in FIG. 7, the grip tube 14 contains a subassembly 26 (also shown in FIG. 8) which includes a vibration motor 28, a printed circuit board 30, an electronic switch 29 and a light 31 mounted on the printed circuit board, and the positive contact 32 for providing battery power to the electronics. These components are assembled within a carrier 34 which also includes battery clamp fingers 36 and a male bayonet portion 38 (also shown in FIG. 5), the functions of which will be discussed in the Battery Clamp and Battery Shell Attachment sections below. The assembly of all the functional electronic components of the razor onto the carrier 34 allows the battery-powered functionality to be pre-tested so that failures can be detected early, minimizing costly scrapping of completed razors. Subassembly 26 also includes a self-adhering insulation sleeve 40, the function of which will be discussed in the Battery Clamp section below. The subassembly 26 is assembled into the grip tube so that it will be permanently retained therein. For example, the subassembly 26 may include protrusions or arms that engage corresponding recesses in the inner wall of the grip tube in an interference fit.

### Battery Shell Attachment

As discussed above, the battery shell 16 is removably attached to the grip tube 14, allowing removal and replacement of the battery. The two parts of the handle are connected, and electrical contact is established between the negative terminal of the battery and the electronic components, by a bayonet connection. The grip tube carries the male portion of the bayonet connection, while the battery shell carries the female portion.

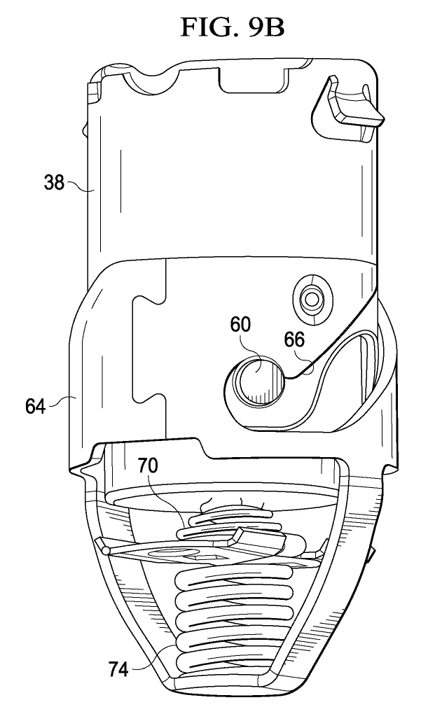

The male bayonet portion 38 of the carrier 34, discussed above, provides the male portion of the bayonet connection. Male bayonet portion 38 carries a pair of protrusions 60 (FIGS. 9A and 9B). These protrusions are constructed to be received and retained in corresponding slots 62 in a female bayonet component 64, carried by the battery shell (FIG. 9A). Each slot 62 includes a lead-in having angled walls 66, 68 (FIG. 9A), to guide each protrusion into the corresponding slot as the battery shell is rotated relative to the grip tube. A detent area 65 (FIG. 9A) is provided at the end of each slot 62. The engagement of the protrusions in the detent areas 65 (FIG. 9B) provides a secure, twist-on mechanical connection of the battery shell to the grip tube.

The carrier 34 and the female bayonet component 64 are both made of metal, and thus engagement of the protrusions with the slots also provides electrical contact between the carrier and the female bayonet component. The carrier is in turn in electrical contact with circuitry of the device, and the negative terminal of the battery is in contact with a battery spring 70 (FIG. 9A) that is in electrical communication with the female bayonet component, and thus contact of the spring members and electrical part ultimately results in contact between the battery and the circuitry of the device.

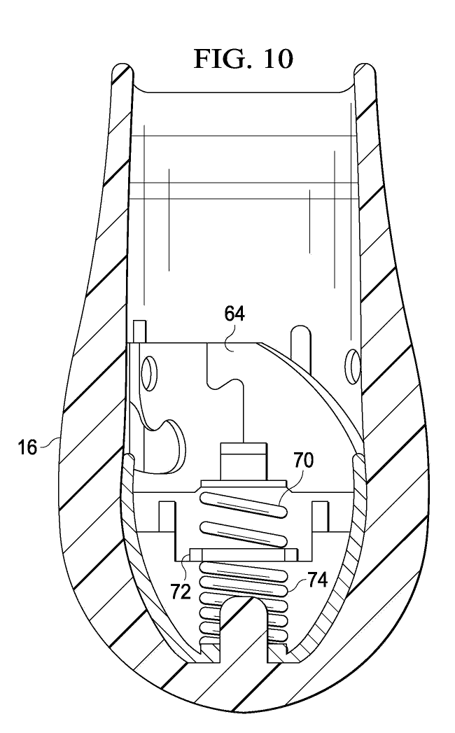

As shown in FIG. 10, the battery spring 70 is mounted on a spring holder 72, which is in turn mounted fixedly to the inner wall of the battery shell 16. The female bayonet component 64 is free to slide axially back and forth within the battery shell 16. In its rest position, the female bayonet component is biased to the base of the battery shell by a bayonet spring 74. The bayonet spring 74 is also mounted on the spring holder 72 and thus its upper end is fixedly mounted with respect to the inner wall of the battery shell. When the battery shell is twisted onto the grip tube, the engagement of the protrusions on the male bayonet component with the angled slots on the female bayonet component draws the female bayonet component forward, compressing the bayonet spring 74. The biasing force of the bayonet spring then causes the female bayonet component to pull the male bayonet component and thus the grip tube toward the battery shell. As a result, any gap between the two parts of the handle is closed by the spring force and the O-ring is compressed to provide a water-tight sealing engagement. When engagement is complete and the protrusions 60 are received into the corresponding V-shaped detent areas 65 of the female bayonet slots 62 (FIGS. 9A and 9B). This is perceived by the user as a clear and audible click, providing a clear indication that the battery shell has been correctly engaged. This click is the result of the action of the bayonet spring causing the protrusions to slide quickly into the V-shaped detent areas 65.

This resilient engagement of the battery shell with the grip tube compensates for non-linear seam lines between the battery shell and grip tube and other geometry issues such as tolerances. The force applied by the bayonet spring also provides solid and reliable electrical contact between the male and female bayonet components.

The spring-loaded female bayonet component also limits the force acting on the male and female bayonet components when the battery shell is attached and removed. If, after the grip tube and battery shell contact each other, the user continues to rotate the battery shell, the female bayonet component can move forward slightly within the battery shell, reducing the force applied by the protrusions of the male bayonet component. Thus, the force is kept relatively constant, and within a predetermined range. This feature can prevent damage to parts due to rough handling by the user or large part or assembly tolerances.

### Battery Clamp

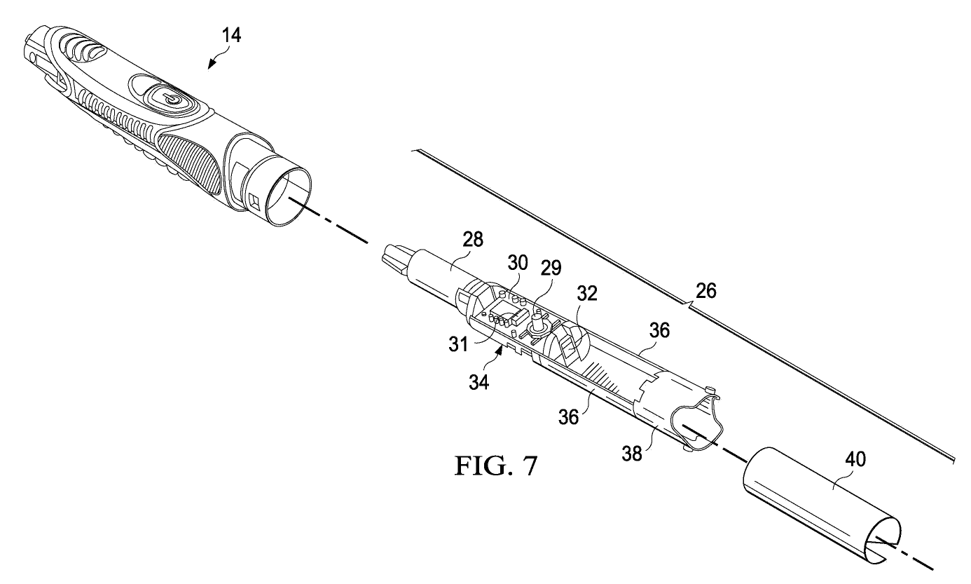

As discussed above, carrier 34 includes a pair of battery clamp fingers 36 (FIG. 7). These fingers act as two springs which exert a small clamping force against the battery 18 (FIG. 5). This clamping force is sufficiently strong so as to prevent the battery from rattling against the inner wall of the grip tube or against other parts, reducing the noise generated by the razor during use. Preferably, the clamping force is also sufficiently strong so as to keep the battery from falling out when the battery shell is removed and the grip tube is inverted. On the other hand, the clamping force should be weak enough so that the user can easily remove and replace the battery. The male bayonet component 38 includes open areas 80 (FIG. 6) through which the battery can be grasped by the user for removal.

The dimensions of the spring fingers and their spring force are generally adjusted to allow the spring fingers to hold the weight of the minimum size battery discussed above, to prevent it from falling out when the razor is held vertical, while also allowing the maximum size battery to be easily removed from the grip tube. To satisfy these constraints, in some implementations it is preferred that, with a coefficient of friction between the battery and foil of about 0.15-0.30, the spring force for one finger be about 0.5 N when a minimum size battery (e.g., having a diameter of 9.5 mm and weight of 15 g) is inserted and less than about 2.5 N when a maximum size battery (e.g., having a diameter of 10.5 mm and weight of 150 g) is inserted. In general, the spring fingers will perform the above functions if, when the razor is held with the battery opening pointing downwards, the minimum size battery will not fall out and the maximum size battery can be taken out easily. Whether the maximum size battery can be taken out easily can be tested, for example, by determining whether the maximum size battery will fall out of its own weight when the battery opening is pointed downwards with the battery shell removed.

In other implementations, other battery sizes and/or weights may be used. The above formulas and examples are provided to give general guidance as to how suitable spring forces may be determined.

Referring to FIGS. 7 and 8, a self-adhering insulation sleeve 40 may provide safety against a short circuit if the battery surface is damaged. As shown in FIG. 8, the self-adhering insulation sleeve 40 may be secured to the battery clamp fingers to hold the sleeve in place when the battery is removed and replaced.

The self-adhering insulation sleeve 40 may comprise a polymer film. Examples of polymer film include polyvinyl chloride, polyvinyl fluoride, vinylidine fluoride, polyester, polyolefin, polypropylene, polyethylene, polyethylene terephtalate, polyamide, polystyrene, and mixtures thereof. The polymer film may be beneficially made of an eco-friendly biodegradable or recyclable material or materials. The polymer film may have a thickness of between about X and about Y, preferably about 0.06 mm. The self-adhering insulation sleeve 40 may be a continuous tube. The self-adhering insulation sleeve 40 may be a tube formed from a sheet of polymer film.

The self-adhering insulation sleeve 40 may comprise a coated surface and a non-coated surface opposite the coated surface. The coated surface may include an adhesive. The adhesive may comprise a pressure-sensitive adhesive. Examples of pressure-sensitive adhesives include acrylic, butyl rubber, ethylene vinyl acetate, natural rubber, nitrile, silicone rubber, styrene block co-polymer, and mixtures thereof. The adhesive may be beneficially made of an eco-friendly biodegradable or recyclable material or materials.

The non-coated surface of the self-adhering insulation sleeve may include at least one indicia. Examples of indicia include branding, battery orientation, battery type, voltage, and combinations thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A battery-powered device comprising:
a housing having a surface comprising a housing wall and constructed to hold at least one battery and;
a self-adhering insulation sleeve inside the housing disposed between the housing wall and the battery along the length of the battery that remains in place when the battery is removed, the self-adhering insulation sleeve comprising a coated surface and a non-coated surface opposite the coated surface wherein the coated surface includes a layer of adhesive.

2. The battery-powered device of claim 1 wherein the self-adhering insulation sleeve comprises a polymer film selected from the group consisting of: polyvinyl chloride, polyvinyl fluoride, vinylidine fluoride, polyester, polyolefin, polypropylene, polyethylene, polyethylene terephthalate, polyamide, polystyrene, and mixtures thereof.

3. The battery-powered device of claim 1 wherein the self-adhering insulation sleeve comprises a polymer film that is an eco-friendly recyclable or biodegradable material.

4. The battery-powered device of claim 1 wherein the adhesive comprises a pressure sensitive adhesive selected from the group consisting of: acrylic, butyl rubber, ethylene vinyl acetate, natural rubber, nitrile, silicone rubber, styrene block co-polymer, and mixtures thereof.

5. The battery-powered device of claim 1 wherein the adhesive comprises a pressure sensitive adhesive that is an eco-friendly recyclable or biodegradable material.

6. The battery-powered device of claim 1 wherein the self-adhering insulation sleeve further comprises at least one indicia on the non-coated surface.

7. The battery-powered device of claim 6 wherein the indicia is selected from the group consisting of: branding, battery orientation, battery type, voltage, and combinations thereof.

8. The battery-powered device of claim 1 further comprising electrically-conductive paths disposed between the housing wall and the battery.

9. The battery-powered device of claim 1 wherein the device is a razor.

10. A handle for a razor having a battery-powered functionality, comprising:
a housing constructed to hold a battery having a length, the housing forming an elongated battery chamber comprising an open end opposing a closed end for receiving the battery through the open end in a direction only along the length of the battery and;
a self-adhering insulation sleeve inside the carrier disposed between the fingers and the battery that remains in place when the battery is removed and replaced comprising a coated surface and a non-coated surface wherein the coated surface includes a layer of adhesive.

11. The razor handle of claim 10 further comprising:
a carrier fixed within the housing made of metal comprising a pair of opposing battery clamp fingers configured to exert a clamping force against the battery for restricting the battery from moving out of the chamber through the open end.

12. The razor handle of claim 11 wherein the fingers extend longitudinally, parallel to the length of the battery, and wherein electrical contact is established between a battery shell and the carrier when the battery shell is placed on said open end of said battery chamber.

13. The razor handle of claim 11 wherein the clamping force is sufficient to prevent the battery from falling out of the housing when the housing is held with a long axis of the housing oriented vertically.

14. The razor handle of claim 11 wherein each finger exerts a spring force of about 0.5 N when a battery having a diameter of 9.5 mm is inserted into the housing, and less than about 2.5 N when a battery having a diameter of 10.5 mm is inserted into the housing.

15. The razor handle of claim 10 wherein the self-adhering insulation sleeve comprises a polymer film selected from the group consisting of polyvinyl chloride, polyvinyl fluoride, vinylidine fluoride, polyester, polyolefin, polypropylene, polyethylene, polyethylene terephthalate, polyamide, polystyrene, and mixtures thereof.

16. The razor handle of claim 10 wherein the self-adhering insulation sleeve comprises a polymer film that is an eco-friendly recyclable or biodegradable material.

17. The razor handle of claim 10 wherein the adhesive comprises a pressure sensitive adhesive selected from the group consisting of acrylic, butyl rubber, ethylene vinyl acetate, natural rubber, nitrile, silicone rubber, styrene block co-polymer, and mixtures thereof.

18. The razor handle of claim 10 wherein the adhesive comprises a pressure sensitive adhesive that is an eco-friendly recyclable or biodegradable material.

19. The razor handle of claim 10 wherein the self-adhering insulation sleeve further comprises at least one indicia on the non-coated surface.

20. The razor handle of claim 19 wherein the indicia is selected from the group consisting of branding, battery orientation, battery type, voltage, and combinations thereof.
